(19) United States
(12) Patent Application Publication
(10) Pub. No.: US 2026/0148754 A1
(43) Pub. Date: May 28, 2026

(54) INTELLIGENT VIDEO EDITOR FOR CREATING NON-LINEAR EDITING TIMELINE

(71) Applicant: Open Video Exploration, Inc., Dover, DE (US)

(72) Inventors: Nathan Frey, Venice, CA (US); Christopher Stauffer, Lincoln, MA (US); Shivam Kotak, Los Angeles, CA (US)

(21) Appl. No.: 19/396,271

(22) Filed: Nov. 20, 2025

Related U.S. Application Data
(60) Provisional application No. 63/724,092, filed on Nov. 22, 2024.

(51) Int. Cl. G11B 27/031

(52) U.S. Cl. CPC G11B 27/031

(57) ABSTRACT

An automated video editing system facilitates the creation of non-linear editing (NLE) timelines using a single prompt from a user. The system automatically ingests digital media, including video, audio, text, and images, and processes them to generate a proxy version with extracted features such as speech transcription, shot detection, facial recognition, and text recognition. A prompt-driven editing engine interprets user input and generates an edit decision list (EDL) using a large language model, which guides the assembly of an edited video timeline. The system also applies advanced editing features-such as captioning, animated title cards, font and color styling, sound effects, and transitions-based on learned user preferences. Additionally, it enables contextual overlays, chapter cards, and hierarchical timelines, while continuously learning user preferences to personalize editing results. The system may be integrated with social media platforms and existing media libraries for content sourcing, customization, and automated publishing.

### TECHNICAL FIELD

This disclosure generally relates to video editing technology, and more particularly to methods and systems for a prompt-based video editor that learns personal editing preferences over time.

### BACKGROUND

The existing process for creating a “rough cut” (e.g., a story) from input videos is a manual process, which includes finding specific interesting or desired moments from the input videos and manually adding them to a timeline, followed by further polish by a senior editor or creator. The specific processes often involve a “string out” process, which includes removing the beginning and end of an input video not usable in any scenario and finding “selects,” i.e., the moments within the input video that may be used to create a story. Next, the selects are put on the timeline to form a story. After this last step, the rough cut is created and given to the senior editor for final adjustments. The current video editing process is cumbersome and time-consuming, which thus discourages people from sharing their stories, especially people with no or minimal video editing experience.

### SUMMARY

To address the aforementioned shortcomings, the disclosure provides an automated video editing system that intelligently gathers media (videos, audios, images, text, etc.) from a video library and uses the gathered clips to create a video story based on user prompt. The user prompt may be a single input describing an objective of the intended video story.

According to some embodiments, automated video editing includes automated ingestion of videos in the library and automated session creation and further editing of the created session. According to some embodiments, the automated video editing further includes the automated generation of animated title cards and chapter cards with AI-written text, AI-selected fonts, AI-selected colors, and AI-generated or selected background music to introduce scenes. According to some embodiments, automated video editing further includes automated generation of captions and automatically selecting fonts and colors based on a user's personal preference and/or content of the video clips. In some embodiments, the automated video editing further includes automatically applying advanced editing effects based on prompts, adjacent content, and story, including but not limited to visual effects (e.g., I-cuts, j-cuts, sound effects, punch-ins, transitions, speed adjustments, color correction, lighting overlays).

According to some embodiments, the automated video editing system disclosed herein allows visualizing the timeline across multiple levels of abstraction, inclusion of overlays of evolving contextual summarizations, important callouts, and links to other sources related to the topic being presented in existing audio/video. According to some embodiments, to facilitate the automated video editing, the system disclosed herein includes an iterative, interactive tool to cluster and label entities in the video (e.g., people, places, things, actions) that can then be referred to from a prompt. In addition, the system disclosed herein may also be equipped with an artificial intelligence (AI) engine for learning a user's style preferences over time based on previous input prompts received from the user and editing the video clips based on the determined user preferences. In some embodiments, the automated editing system may also be equipped with an AI tool for ideating new projects from past projects, existing media, related material from other sources, and user prompts.

According to some embodiments, the automated video editing system may be configured to further gather the existing social media content of a user and feed it into suggested editing workflows. For example, the automated video editing system may implement a mechanism for monitoring media streams (e.g., social media) to find posts of interest and ideate responses. According to some embodiments, when identifying interesting video clips from the media library of the user or from the social media content, multiple feature types may be explored to ensure proper video clips are identified.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, and the accompanying figures (or drawings). A brief introduction of the figures is below.

FIG. 1 illustrates an example automated video editing process, according to some embodiments of the disclosure.

FIGS. 2A-2B illustrate an example user interface for a user to provide a prompt when creating a session, according to some embodiments of the disclosure.

FIG. 3 illustrates an example prompt directed to a specific part to make changes to that specific part of a created session, according to some embodiments of the disclosure.

FIG. 4 illustrates some example fonts, background colors, and text selected for certain parts of video sessions, according to some embodiments of the disclosure.

FIG. 5A illustrates an example of adding captions to a video session, according to some embodiments of the disclosure.

FIG. 5B illustrates an example of changing font color for different scenes in a video session, according to some embodiments of the disclosure.

FIG. 6 illustrates some example application scenarios to use sound effects, according to some embodiments of the disclosure.

FIG. 7A illustrates an example high-level view of each scene/chapter included in an automatically created labeled multi-hierarchical timeline, according to some embodiments of the disclosure.

FIG. 7B illustrates an example low-level view of each audio track (green) and each video track (gray), according to some embodiments of the disclosure.

FIG. 8 illustrates a couple of example visuals generated for what is being talked about in an audio/video file, according to some embodiments of the disclosure.

FIG. 9 illustrates an example classification scenario, according to some embodiments of the disclosure.

FIG. 10 illustrates an example visual media card, according to some embodiments of the disclosure.

FIG. 11 is a block diagram of an example computer for implementing the technology disclosed herein, according to some embodiments of the disclosure.

### DETAILED DESCRIPTION

The figures (FIGS.) and the following description relate to some embodiments only by way of illustration. It should be noted that from the following discussion, alternative embodiments of the structures and methods disclosed herein will be readily recognized as viable alternatives that may be employed without departing from the principles of the disclosure.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

To address the aforementioned problems in the existing video editing and video-based storytelling technologies, the present disclosure describes an automated video editing system that is configured to automatically gather media (videos, audios, images, text, etc.) from a library and create a non-linear editing (NLE) timeline with advanced effects in response to a single prompt from a user. The created non-linear editing timeline can be automatically generated without any additional user input, such as complicated video cuts, text input, font selection, background music incorporation, and so on. In addition, the automated video editing system can also learn user preferences from experiences, so that the created non-linear editing timeline can be automatically customized to a specific user.

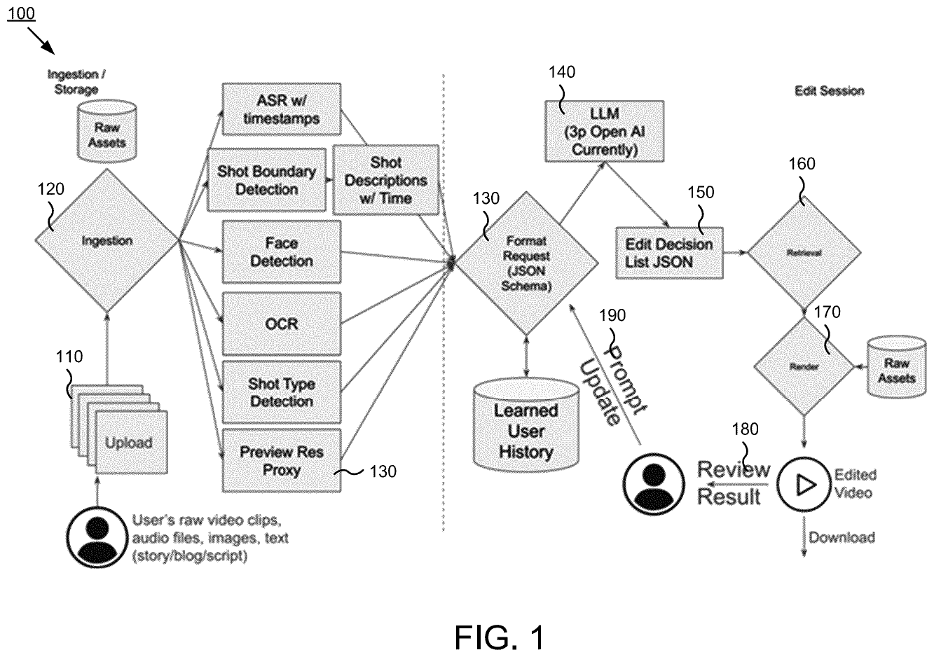

FIG. 1 illustrates an example automated video editing process 100, in accordance with an embodiment of the present disclosure. Briefly, the automated video editing process 100 may be divided into three consecutive processes, that is, ingestion, session creation, and editing.

For ingestion, a user may upload digital media such as raw videos, already edited videos, audio files, images, and text (story/blog/movie script) to the disclosed system at step 102. Once uploaded, the raw digital media may be ingested at step 104. The ingestion may include a process of transcoding the raw digital media into a small version “proxy” with features extracted from the video. The exemplary ingestion processes may include but are not limited to Automatic Speech Recognition (ASR) with speaker labeling, shot boundary detection with timestamps-thumbnail of shot labeled with a text description using an ML model, Face Detection with identity recognition, optical character recognition (OCR) and shot type detection. This is stored for each video. In some embodiments, additional preview of the ingested proxy may be performed, to ensure the accuracy and consistency of the data ingestion. In some embodiments, the ingested data as well as the raw digital media uploaded by the user may be stored in the datastore for later retrieval and processing. For example, a user may check his/her digital media library uploaded to the system through a user interface, where the library lists the digital media name and icon of each uploaded digital media. The user may select one or more digital media for storytelling. In some embodiments, the automated video editing system may automatically identify relevant digital media for storytelling without requiring a user to select specific digital media from his/her library.

In some embodiments, the uploaded digital media such as videos may have different content. For example, for uploaded videos related to a recent trip to Africa, one or more videos may include clips taken of animals during the trip, and one or more videos may include the user talking about his trip to Africa.

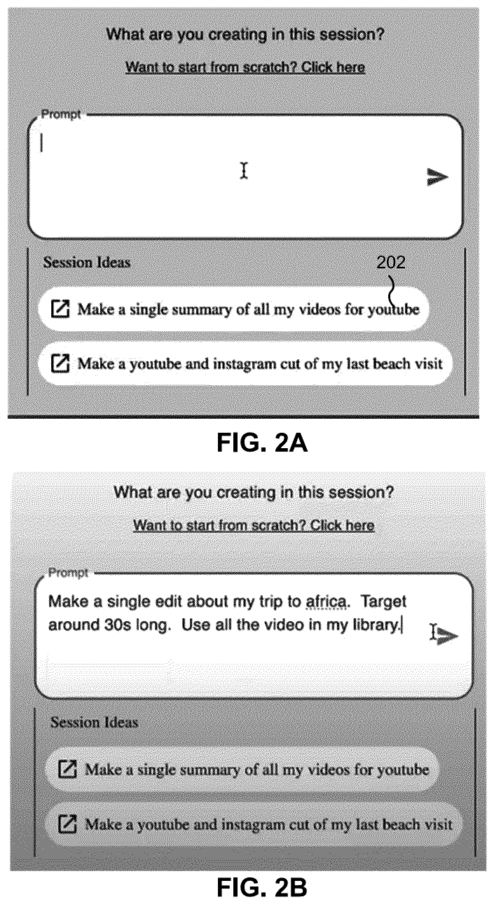

For session creation, it refers to the process of starting a new editing session in response to a user-provided prompt. FIG. 2A illustrates an example user interface for a user to provide a prompt when creating a session. The prompt input by the user may indicate an objective of the to-be-created session. For example, a user may input a prompt “Make a single edit about my trip to Africa. Target around 30 seconds. Use all videos in the library,” as shown in FIG. 2B. In another example, a user may input a prompt “Make a 30s cut of my trip to Africa, make sure to include all the giraffe videos and it's for Instagram so it should be portrait.”

As can be seen, the prompt may indicate the topic or objective of the to-be-created session, as well as the target time length of the to-be-created session. In addition, the prompt may also include which video(s) should be considered from the library when creating the session. However, it should be noted that the time length and the video selection are not necessarily included in the prompt input by the user. Instead, these values may be automatically determined by the automated video editing system. Alternatively, these values may be set to default values. For example, a to-be-created session may always consider all videos in the library to be the default. The automated video editing system may then identify relevant videos to be included in the to-be-created session based on the content ingested during the ingestion process. As can be also seen from FIGS. 2A-2B, in some embodiments, some pre-generated prompts 202 may be provided under the user input window, allowing a user to select a session idea without necessarily typing the prompt when creating a session.

Referring back to FIG. 1, after receiving the prompt provided by the user, the session creation may automatically start, which may be referred to as the editing process described above. The specific process may include but is not limited to the following described processes. In one example automated process, the prompt, features of each asset in the session, and history of the user's behavior are formatted at step 130 and sent to the LLM at step 140 along with a JSON schema (provided at the end of the application) the result must be formatted in. The formatted result is returned from the LLM and server as an edit decision list (EDL) 150. Some of the EDL is ambiguous and so it is passed to the retrieval process, at step 160, that best fulfills the EDL's requested requirements. That result is passed to a high-speed render along with the proxy video files at step 170. Finally, an edit is created and shown to the user at step 180.

In some embodiments, the system may be configured to generate an explainability layer corresponding to each edit decision, wherein a natural language explanation or visual annotation is presented to the user, describing the rationale for inclusion of a scene, font, caption, or effect. This may include inferred emotional tone, recognized patterns from past projects, or content alignment with prompt objectives. Such transparency may be selectively toggled by the user to assist in reviewing automated edits.

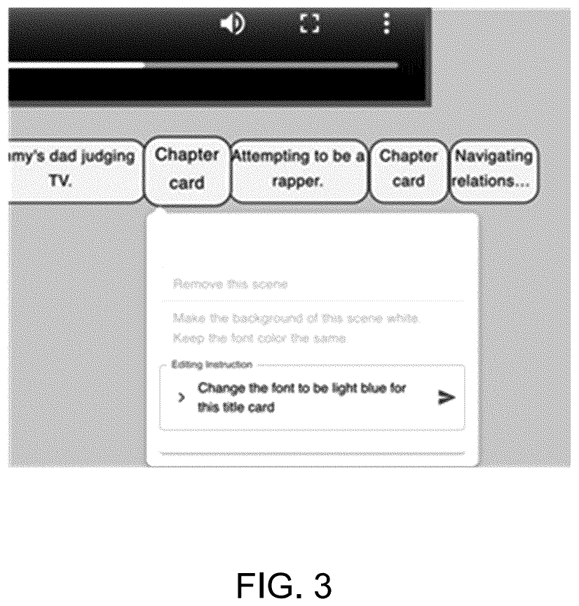

In some embodiments, once the session is automatically created and presented to the user, the user may review and provide additional prompts at step 190 to update the created session before the session can be finalized for publishing or delivery to specific entities. In one scenario, the user may type a prompt to update the fully created session. An example prompt may be “Remove the second scene in the video, add more shots of the elephants, don't show my face in the last scene, and actually make it 45 seconds long.” In another scenario, the user types a prompt directed to a specific part to make changes to that specific part of the created session. FIG. 3 illustrates an example prompt “Change the font to be light blue for this title card.” The automatically selected font color at the beginning may be not what the user prefers, and thus the user can use the additional prompt to make further changes. In some embodiments, these additional prompts may be learned by the automated video editing system, which can select the preferred font color next time for the user. From FIG. 3, it can be also seen that there are many specific parts from which the user can select for additional editing by providing additional prompts.

In practical applications, the user may repeat the additional “prompt process” until s/he is satisfied with the result. At this point, the user can either export the video to post to a location for storage, or the user can use the integration, provided by the system, with the social media to post the created session. In some embodiments, the EDL can be further exported in a format compatible with Adobe Premiere, Apple Final Cut Pro, and other popular software for different purposes, which is not limited in the present disclosure.

In some embodiments, the system may expose an application programming interface (API) to enable integration with external platforms or third-party applications. Through the API, external systems may submit digital media assets, specify editing prompts, retrieve rendered videos, or access edit decision lists. The API may be REST-based and support authentication protocols such as OAuth, API keys, or tokens, and may also expose endpoints for metadata querying, media tagging, and batch video generation.

In some embodiments, all interactions of the user with the disclosed system can be tracked by the back end for improving the full system and personal suggestions for each user.

In the following, specific details for automatically generating a video session are further described from different aspects of video editing.

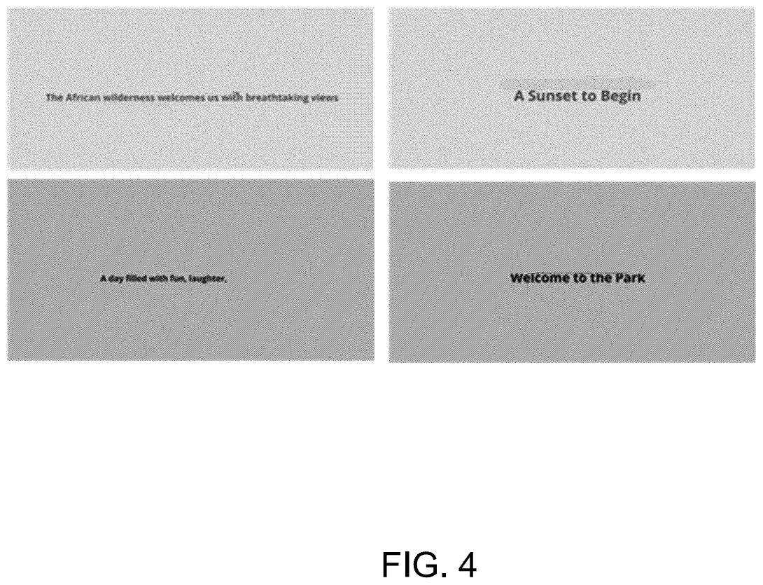

In one example implementation, the automated video editing system disclosed herein may generate animated title cards and chapter cards with AI-written text, AI-selected fonts, AI-elected colors, and AI-generated or selected background music to introduce scenes. The generated title cards and chapter cards may be automatically added specific parts to introduce scenes that are related to the content that comes after them. In some embodiments, the possible AI controls for editing may include but are not limited to the tools for selection of font, background color, foreground color, the text itself, and music (AI-generated or human-created). FIG. 4 illustrates some example fonts, background colors, and text selected for certain parts of a video session(s), according to some embodiments of the present disclosure.

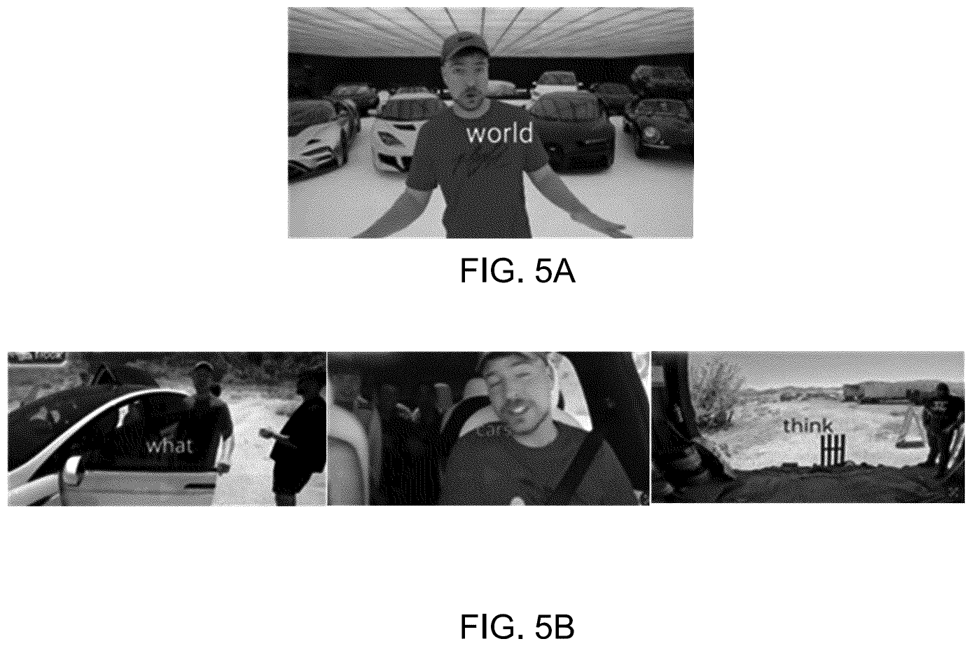

In another example implementation, the automated video editing system disclosed herein may generate captions and automatically select fonts and colors based on the user's personal preferences or the content of the video edit. For example, the user may input a prompt “Make the captions funny, make the colors more fun, use dramatic sound effects,” or “Use a specific font.” In some embodiments, the automated video editing system may also learn the user's preferences over time. In the existing video editing processes, a user has to know a specific font name. With the automated video editing system disclosed herein, the user can refer to the font name in his/her own words as if the user is explaining what they want to an editor. In one example, as shown in FIG. 5A, the user may want to add captions to a video session. The user just needs to provide a prompt “Add captions” through the user interface. The automated video editing system disclosed herein then automatically adds captions to the video, including automatically coloring the added captions, as shown in FIG. 5A. In another example, as shown in FIG. 5B, the user may want to change font color for different scenes. To achieve this, the user just needs to provide a prompt “Have the captions change color on each scene.” The automated video editing system then automatically changes font colors for different scenes when creating or revising the created session, as can be seen in FIG. 5B.

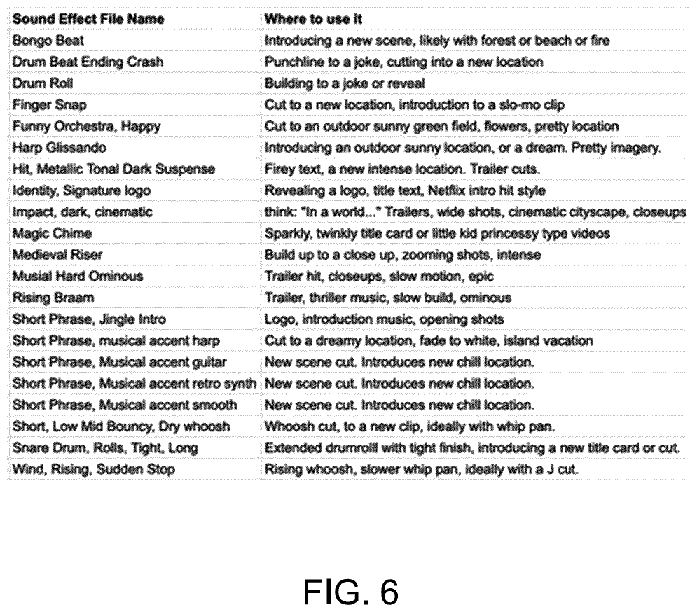

In another example implementation, the automated video editing system disclosed herein may automatically apply advanced editing effects based on prompts, adjacent content, and story, including but not limited to visual effects (I-cuts, j-cuts, sound effects, punch-ins, transitions, speed adjustments, color correction, lighting overlays). In some embodiments, the automated video editing systems may include one or more machine learning models such as LLM models that can be trained through supervised training (or unsupervised training under certain circumstances). For example, working with professional video editors, a set of assets and text descriptions of when to use them, along with user preferences, and the EDL returns when/where to apply the effects, can be provided to the machine learning model for systematical training, which, once properly trained, can then automatically apply the assets and text descriptions to the created video session. FIG. 6 lists some example application scenarios to use sound effects, in accordance with some embodiments of the disclosure.

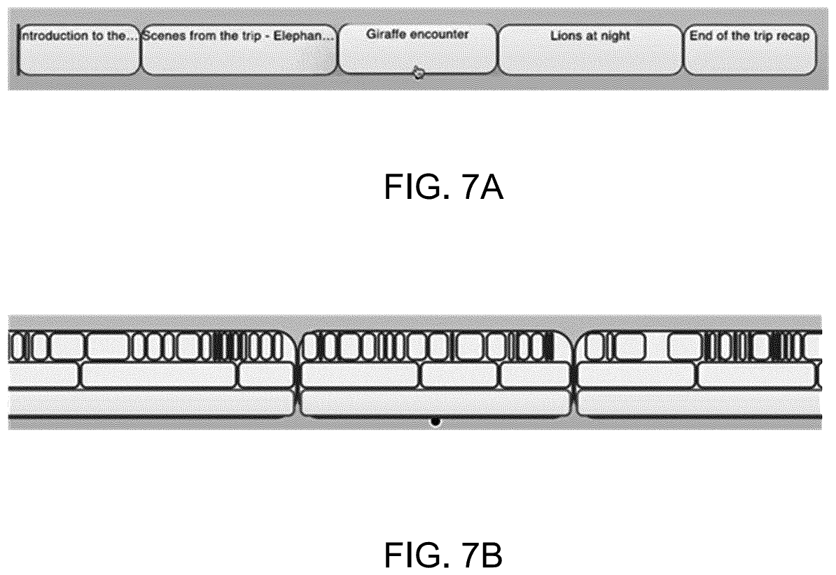

In another example implementation, the automated video editing system disclosed herein may be configured to allow to visualize the timeline across multiple levels of abstraction. For example, the automated video editing system may be configured to generate an automatically labeled/created, multi-hierarchical timeline, through which the user can find parts of the video cut from a high level and then zoom to view additional details of a section. FIG. 7A provides an example high-level view of each scene/chapter included in an automatically created labeled multi-hierarchical timeline, and FIG. 7B provides an example low-level view of each audio track (green) and each video track (gray), according to some embodiments of the disclosure.

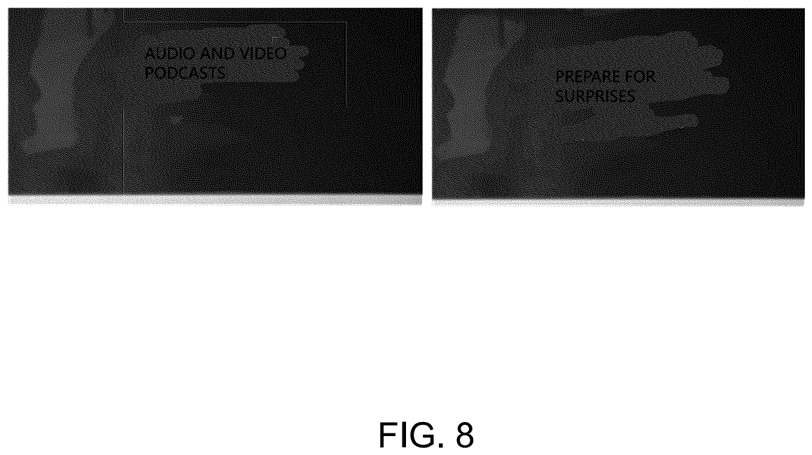

In another example implementation, the automated video editing system disclosed herein may provide overlays of evolving contextual summarizations, important callouts, and links to other sources related to the topic being presented in existing audio/video. In one example, the automated video editing system may take an audio or video file and then use ASR to understand what is being talked about or shown. Under certain circumstances, the user may provide a prompt to request visuals to be generated to go along with the content. In response, the automated video editing system may automatically generate visuals, which can be timed with the topics being discussed. These visuals can be text, AI-generated images, background bios, images from the web, profile pictures, etc. In some embodiments, when viewing the visuals, the user may also use additional prompts to make desired changes, such as “Remove ‘ALERT: prepare for a surprise’ from scene 2 and also in general use a more serious tone.” FIG. 8 illustrates a couple of example visuals generated for what is being talked about in an audio/video file, according to some embodiments of the disclosure.

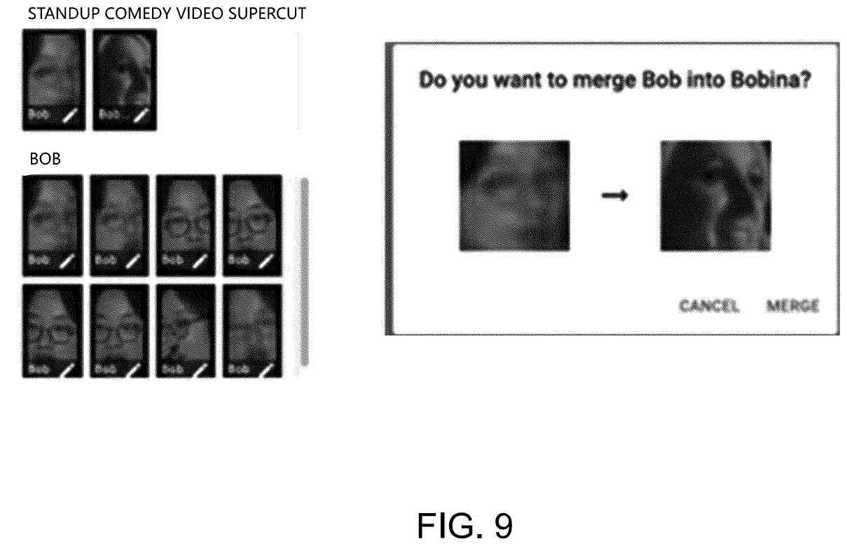

In another example implementation, the automated video editing system disclosed herein may include an iterative, interactive tool to cluster and label entities in the video (e.g., people, places, things, actions) that can then be referred to from a prompt. For example, the automated video editing system disclosed herein may extract compact representations of the entities present in ingested digital media. This includes faces, people, pets, objects, locations, actions, and so on. The automated video editing system may then provide an interface to interactively adjust the classification for each entity and name the entities. The system may adapt models from past digital media to future digital media to automatically classify previously labeled entities. These labeled entities may be used later to augment the description of the video used in directed prompting. FIG. 9 illustrates an example classification scenario, according to some embodiments of the disclosure.

In some embodiments, the system may further include a bias detection module or content sensitivity filter that automatically flags portions of the ingested media or generated video segments for potentially sensitive, inappropriate, or biased content. The filtering may occur during ingestion, editing, or prior to final export. Detected content may be automatically excluded, redacted, blurred, or subject to user approval before incorporation. The filtering mechanism may rely on pretrained models aligned with ethical guidelines or content safety rules, including but not limited to hate speech, violence, nudity, or misinformation.

In another example implementation, the automated video editing system disclosed herein may learn a user's style preferences over time based on input prompts, as briefly described earlier. For example, the automated video editing system disclosed herein may record user interactions within editing sessions, as well as the result of processing. The user's prompts and user's reaction to automated editing may be collected and used to provide reinforcement feedback about and self-supervised training for learning while editing actions and effects to apply and when.

In some embodiments, the system may include a dedicated training mode, whereby the user is invited to review and rate automated editing results, provide direct comparisons between alternative edits, or annotate preferred styles using selectable UI elements. This training mode may facilitate reinforcement learning or fine-tuning of model parameters specific to that user profile. The user-specific training data may be stored locally or in a privacy-compliant cloud module and may be applied in subsequent session generations to optimize automatic decision-making and personalization.

In another example implementation, the automated video editing system disclosed herein may include a tool for ideating new projects from past projects, existing media, related material from other sources, and user prompts. For example, user information that is available to the disclosed system, e.g., user demographic information, digital media metadata, session contents, session editing style, linked social media accounts, and user prompts may be used to provide guidance and suggestions for new media sessions. In addition, trending media topics, current search engine optimization trends, and other external sources may be also considered. These suggestions may be used to create pending editing sessions and to seed the prompts and digital media selections to provide a fast track to creating new sessions described above.

In another example implementation, the automated video editing system disclosed herein may be configured to gather existing social media content of the user and feed it into suggested editing workflows. For example, linked social media accounts may be surveyed for existing digital media shared by the user to help customize and adapt the ideated sessions and to bias the suggested prompts and prompt returns.

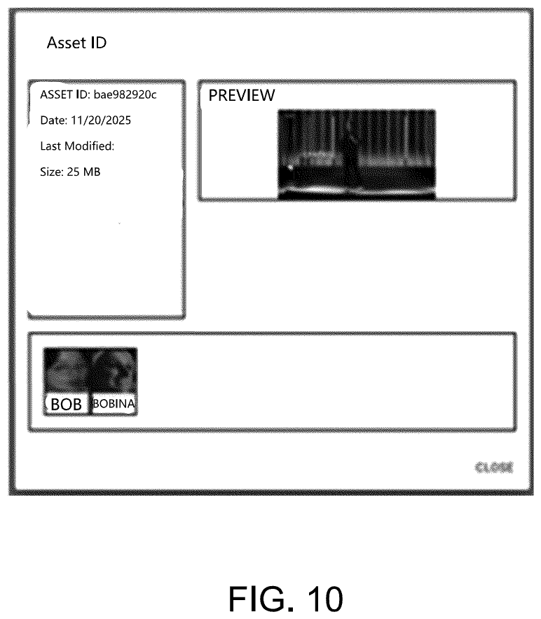

In another example implementation, the automated video editing system disclosed herein may explore and visualize the user's media library using multiple feature types. For example, a visual media card designed to enable visualization of the digital media's origination metadata, file location, characteristics, extracted features, tagged entities, and available additional processing may provide a uniform view of different media sources. FIG. 10 illustrates an example visual media card, according to some embodiments of the disclosure. In some embodiments, a multi-level, multi-factor filtered grouping user interface may be configured to provide the ability to group and label media across multiple characteristics and attributes. In addition, a “proto-card” may be further configured to provide an interface for querying any aspect of the description to return media that meet that criteria.

In some embodiments, the system may construct and maintain a semantic graph of ingested and edited media assets, wherein nodes represent people, places, events, entities, and clips, and edges define relationships or contextual relevance between them. This graph structure may support contextual search, continuity tracking across projects, and semantic querying. For example, a prompt such as “show me other clips where this person appears in a celebratory setting” may be resolved using the semantic graph structure.

In another example implementation, the automated video editing system disclosed herein may implement a mechanism for monitoring media streams (e.g., social media) to find posts of interest and ideate responses. For example, the user's linked accounts may be monitored to provide metric feedback on submitted digital content and to provide suggestions for responding to media that the user has interacted with or to mentions/tags of the user as well.

It should be noted that the above-described embodiments and example implementations are provided for exemplary purposes, but not for limitations. The disclosed automated video editing system may include additional functions not described above. In the following, an example computing device for implementing the above-described functions of the disclosed automated video editing system is further described.

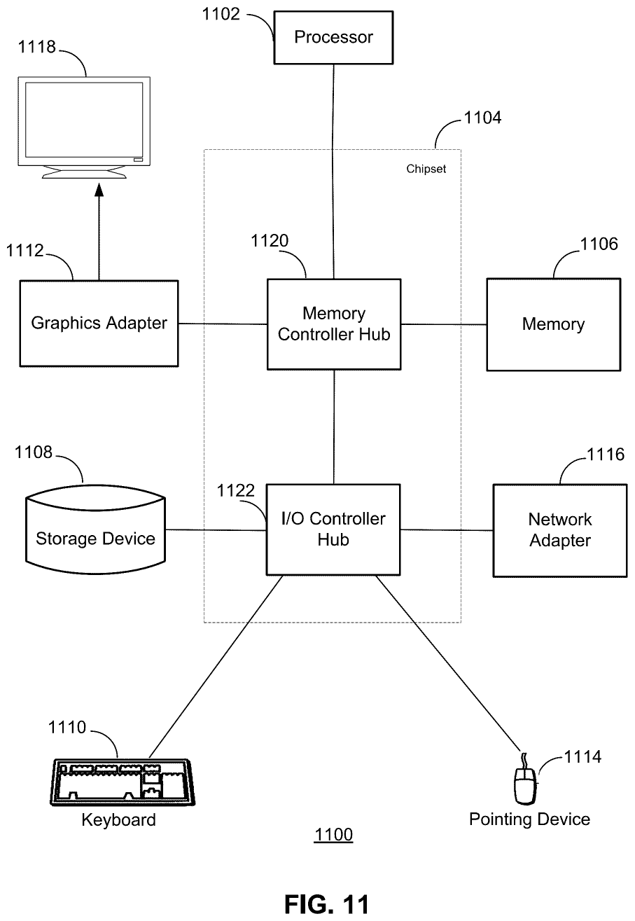

FIG. 11 depicts an example computing device 1100 for implementing systems and methods described in reference to FIGS. 1-10. Examples of a computing device may include a personal computer, desktop computer, laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, edge devices, IoT devices, and the like.

In some embodiments, the computing device 1100 includes at least one processor 1102 coupled to a chipset 1104. The chipset 1104 includes a memory controller hub 1120 and an input/output (I/O) controller hub 1122. A memory 1106 and a graphics adapter 1112 are coupled to the memory controller hub 1120, and a display 1118 is coupled to the graphics adapter 1112. A storage device 1108, an input interface 1114, and network adapter 1116 are coupled to the I/O controller hub 1122. Other embodiments of the computing device 1100 have different architectures.

The storage device 1108 is a non-transitory computer-readable storage medium such as a hard drive, compact disk read-only memory (CD-ROM), DVD, or a solid-state memory device. The memory 1106 holds instructions and data used by the processor 1102. The input interface is a touch-screen interface, a mouse 1114, trackball, or other types of input interface, a keyboard 1110, or some combination thereof, and is used to input data into the computing device 1100. In some embodiments, the computing device 1100 may be configured to receive input (e.g., commands) from the input interface 1114 via gestures from the user. The graphics adapter 1112 displays images and other information on the display 1118. The network adapter 1116 couples the computing device 1100 to one or more computer networks.

The computing device 1100 is adapted to execute computer program modules for providing the functionality described herein. As used herein, the term “module” refers to computer program logic used to provide the specified functionality. Thus, a module may be implemented in hardware, firmware, and/or software. In one embodiment, program modules are stored on the storage device 1108, loaded into the memory 1106, and executed by the processor 1102.

In some embodiments, the disclosed system may be configured for edge deployment, wherein certain editing operations, inference steps, or prompt resolution tasks are executed locally on the device without requiring continuous cloud connectivity. A lightweight version of the editing engine and language model may be deployed in environments with limited bandwidth or offline operation modes, and results may later be synchronized with cloud-based infrastructure when connectivity is re-established.

The types of computing devices 1100 may vary from the embodiments described herein. For example, the computing device 1100 may lack some of the components described above, such as graphics adapters 1112, input interface 1114, and displays 1118. In some embodiments, a computing device 1100 may include a processor 1102 for executing instructions stored on a memory 1106.

The methods disclosed herein may be implemented in hardware or software, or a combination of both. In one embodiment, a non-transitory machine-readable storage medium, such as the one described above, is provided, the medium comprising a data storage material encoded with machine-readable data which, when using a machine programmed with instructions for using said data, is capable of displaying any of the datasets and execution and results of this disclosure. Such data may be used for a variety of purposes. Embodiments of the methods described above may be implemented in computer programs executing on programmable computers, comprising a processor, a data storage system (including volatile and non-volatile memory and/or storage elements), a graphics adapter, an input interface, a network adapter, at least one input device, and at least one output device. A display is coupled to the graphics adapter. Program code is applied to input data to perform the functions described above and generate output information. The output information is applied to one or more output devices, in a known fashion. The computer may be, for example, a personal computer, microcomputer, or workstation of conventional design.

Each program may be implemented in a high-level procedural or object-oriented programming language to communicate with a computer system. However, the programs may be implemented in assembly or machine language, if desired. In any case, the language may be a compiled or interpreted language. Each such computer program is preferably stored on a storage media or device (e.g., ROM or magnetic diskette) readable by a general or special-purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

The databases thereof may be provided in a variety of media to facilitate their use. The databases of the present disclosure may be recorded on computer-readable media, e.g., any medium that may be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art may readily appreciate how any of the presently known computer readable mediums may be used to create a manufacture comprising a recording of the present database information. “Recorded” refers to a process for storing information on a computer-readable medium, using any such methods as known in the art. Any convenient data storage structure may be chosen, based on the means used to access the stored information. A variety of data processor programs and formats may be used for storage, e.g., word processing text files, database format, etc.

Here the following is an example JSON schema described earlier in FIG. 1:

```
{
  “type”: “object”,
  “properties”: {
  “movie_title”: {
    “description”: “Title of the movie”,
    “type”: “string”
  },
  “movie_aspect_ratio”: {
    “description”: “Aspect ratio of the movie”,
    “type”: “string”
  },
  “scenes”: {
    “type”: “array”,
    “description”: “A scene within an OVX timeline”,
    “items”: {
    “oneOf”: [
      {
      “video_scene”: {
        “type”: “object”,
        “description”: “A scene within an OVX timeline made of up edited video.”,
        “properties”: {
        “scene_description”: {
          “description”: “High level description of the scene”,
          “type”: “string”
        },
        “spoken_words”: {
          “description”: “Spoken words with timestamps from original edited transcript.”,
          “type”: “string”
        },
        “suggested_visual_shots”: {
          “description”: “Visual shots to be shown with the edited transcript.”,
          “type”: “array”,
          “items”: {
          “description”: “A visual shot to be shown with the edited transcript.”,
          “type”: “object”,
          “properties”: {
            “video_id”: {
            “description”: “ID of the video the shot comes from.”,
            “type”: “string”
            },
            “shot_id”: {
            “description”: “The id of the shot.”,
            “type”: “string”
            }
          }
          }
        },
        “captions”: {
          “type”: “object”,
          “properties”: {
          “render_captions”: {
            “description”: “Render captions for the spoken words in the video at the bottom center.”,
            “type”: “boolean”
          },
          “font”: {
            “description”: “Font to use in the rendered captions. This must be a google font”,
            “type”: “string”
          },
          “color”: {
            “description”: “Color to use for the rendered captions.”,
            “type”: “string”
          }
          }
        }
        }
      }
      },
      {
      “chapter_card”: {
        “type”: “object”,
        “description”: “A scene within an OVX timeline made of up graphics, usually used as a first
scene (title card) or before a new section (chapter card).”,
        “properties”: {
        “main_title”: {
          “description”: “Title to use for this chapter. Try to think of something clever, cute or fun or
match the style.”,
          “type”: “string”
        },
        “sub_title”: {
          “description”: “Subtitle to use for this chapter. There is a lot of room for character here so feel
free to be creative and descriptive.”,
          “type”: “string”
        },
        “background_color”: {
          “description”: “Color to use for the chapter card background”,
          “type”: “string”
        },
        “font_color”: {
          “description”: “Color to use for the chapter card font. It should go well with the background
color.”,
          “type”: “string”
        },
        “sound_effect”: {
          “type”: “string”,
          “description”: “Sound effect to play when the chapter card is shown.”,
          “enum”: [
          “Whoosh_deck.mp3”,
          “ES_Short,Deep,Dry.mp3”,
          “ES_Short_Phrase,Musical_Accent,Percussion05.mp3”,
          “ES_Short_Phrase,Musical_Accent,Percussion_02.mp3”,
          “ES_Short_Phrase,Musical_Accent,Notification,Attention,Marimba08.mp3”,
          “ES_Short_Phrase,Musical_Accent,Experimental_03.mp3”,
          “ES_Metallic_Impact,Hit,Dark,Distorted.mp3”,
          “ES_Light,Dark,Magic_Impacts,Large_10.mp3”,
          “ES_Designed,Bass_Stinger.mp3”
          ]
        }
        }
      }
      }
    ]
    }
  }
  },
  “required”: [
  “movie_title”,
  “movie_aspect_ratio”,
  “scenes”
  ]
}
```

1. An automated video editing system, comprising:
a) a memory storing instructions; and
b) a processor configured to execute the instructions to:
i) ingest a plurality of digital media assets, the digital media assets comprising at least one of video, audio, image, and text;
ii) generate proxy media files from the ingested digital media assets by extracting media features including at least one of speech transcriptions, shot boundaries, face detections, optical character recognition (OCR) data, and shot type categorizations;
iii) receive a user prompt defining an objective for a video session;
iv) generate an edit decision list (EDL) based on the user prompt, user history, and extracted media features using a language model;
v) retrieve relevant media segments from the ingested media based on the EDL;
vi) render an edited video timeline comprising the retrieved media segments; and
vii) apply at least one automated editing effect including animated chapter cards, caption generation, color selection, audio effects, or visual transitions, wherein the editing effect is selected based on content context or learned user preferences.

2. The system of claim 1, wherein the edit decision list is formatted according to a pre-defined JSON schema comprising fields for scene descriptions, suggested visual shots, and captions.

3. The system of claim 1, wherein the proxy media files are generated by transcoding the original digital media into lower resolution representations with associated metadata.

4. The system of claim 1, wherein the processor is further configured to receive iterative prompts from the user to update one or more specific scenes of the rendered video timeline.

5. The system of claim 1, wherein the applied animated chapter cards comprise AI-generated text, AI-selected fonts, and AI-selected background music.

6. The system of claim 1, wherein the caption generation is responsive to speech-to-text transcription and includes automatic font selection and color styling based on the emotional tone or visual content of the scene.

7. The system of claim 1, wherein the system is configured to generate a multi-level hierarchical timeline view including scene-level and track-level visualizations.

8. The system of claim 1, wherein user preferences are inferred from past editing sessions and are used to personalize subsequent video generation tasks.

9. The system of claim 1, wherein the processor is further configured to classify and label entities detected in the ingested media, including people, places, objects, and actions.

10. The system of claim 9, wherein the classified entities are interactively editable by the user through a graphical interface.

11. The system of claim 1, wherein the applied audio effects include sound files selected from a curated library based on scene transition type or user instruction.

12. The system of claim 1, wherein the system is configured to integrate with social media accounts to import existing media or post generated videos.

13. The system of claim 1, wherein the system includes a media visualization interface configured to display metadata, feature extractions, and tagging information for each media asset.

14. The system of claim 1, wherein the processor is further configured to detect and suggest new editing sessions based on a user's past projects, trending topics, and metadata analysis.

15. The system of claim 1, wherein the processor is configured to export the edit decision list in a format compatible with third-party professional editing software.

16. The system of claim 1, wherein the user prompt includes specifications for media orientation, target video length, or mandatory content inclusion.

17. The system of claim 1, wherein the processor is further configured to generate AI-created visuals to supplement existing audio content, based on topic recognition via automatic speech recognition (ASR).

18. The system of claim 1, wherein the system provides feedback-driven learning by capturing user prompt history and subsequent edits.

19. The system of claim 1, wherein the processor is further configured to modify background color, font, and layout of captions based on a scene-specific style engine.

20. The system of claim 1, wherein the system enables rendering and playback of the edited video timeline within a user interface that allows granular prompt-based revisions.
